(19) United States
(12) Patent Application Publication
(10) Pub. No.: US 2010/0274544 A1
(43) Pub. Date: Oct. 28, 2010

(54) SQUIB SIMULATOR

(75) Inventor: David R. Rachels, Clayton, NC (US)

Correspondence Address: PERKINS COIE LLP;PATENT-SEA, P.O. BOX 1247, SEATTLE, WA, 98111-1247, US

(73) Assignee: Armtec Defense Products Co., Coachella, CA (US)

(21) Appl. No.: 11/683,694

(22) Filed: Mar. 8, 2007

Related U.S. Application Data
(60) Provisional application No. 60/780,483, filed on Mar. 8, 2006.

(51) Int. Cl. G06G 7/70; G06G 7/48

(52) U.S. Cl. 703/8; 703/6

(57) ABSTRACT

The present invention is generally directed toward testing devices. For example, one aspect of the invention is directed toward a simulation device that includes an indicator circuit configured to simulate a characteristic of a countermeasure initiation device. The indicator circuit can be switchable between at least two states including a ready state and an unavailable state. The system can further include a switching circuit operably coupled to the indicator circuit to switch the indicator circuit between the at least two states.

### CROSS REFERENCE TO RELATED APPLICATIONS

The present application claims the benefit of U.S. Provisional Patent Application No. 60/780,483 filed on Mar. 8, 2006, entitled SQUIB SIMULATOR, the entirety of which is incorporated herein by reference.

### TECHNICAL FIELD

The present invention is related to aircraft defense systems, and more particularly to test apparatus and related methods for aircraft defense systems.

### BACKGROUND

Military aircraft have numerous systems to defend the aircraft and crew against attack. One of the primary defense systems is used to deploy chaff as a countermeasure against radar guided munitions and flares as a countermeasure against heat seeking devices. Chaff and flare rounds are cartridges which are loaded into magazines and deployed by a pulse of electrical current sent to each round individually. The aircraft's magazines hold numerous quantities of each in order to provide defense against multiple attacks. The aircraft's electronics not only sends the electrical pulse to fire the countermeasure but also continuously monitors the magazine to know how many rounds remain available and what positions in the magazine they occupy. This information is vital to the aircraft's crew and the ability to defend against aggressive tactics. There are a number of parameters the aircraft's electronics monitor in order to provide this information to the crew. An available round will have a specific resistance across the electrical contacts that deliver the firing pulse. A spent round will have a much different resistance across the same contacts. When the aircraft sends the firing pulse to a round, it monitors the time it takes for this change in resistance to occur. If the change is faster or slower than specified the round is determined to have failed.

When designing and or testing these deployment systems it is advantageous to avoid using live rounds. For example: They are expensive. They are messy; Strands of chaff foul electrical equipment and sensors. They require extra safety precautions. And, they are “one-time” in use and must be continuously replaced as they are test fired.

Inert devices which have the same ignition sources as live rounds but without the additional energetic material have been used but they also have disadvantages. For example: They are expensive. They are “one-time” in use and must be continuously replaced as they are test fired. It is difficult to determine visually if the round successfully fired.

### SUMMARY

The present invention provides an electronic device and related methods that overcomes drawbacks experienced by the prior art and that provide additional benefits. In one embodiment, a squib simulator and related methods are provided that allow designers and developers of military aircraft to test the aircraft's defense system without using live rounds or expensive, one-time use inert rounds.

### BRIEF DESCRIPTION OF THE DRAWINGS

FIG. 1 is a partially schematic circuit diagram of a squib simulator in accordance with an embodiment of the present invention.

FIG. 2 is a partially schematic functional block diagram of a squib simulator in accordance with an embodiment of the present invention.

FIG. 3 is a partially schematic illustration of a vehicle with a defensive system.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with aircraft defense systems and components thereof have not been shown or described in detail to avoid unnecessarily obscuring the description of the embodiments of the invention.

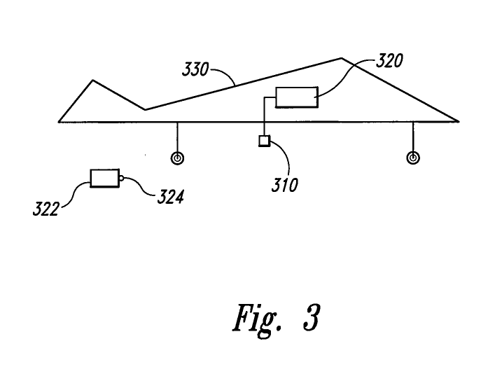

As shown in FIG. 3, in selected embodiments a test device or simulation device 310 can be coupled to a portion of a defensive system 320 so that the portion of the defensive system 320 can be tested. For example, in certain embodiments the simulation device 310 can include a squib simulator for simulating a squib 324 used to deploy or fire a countermeasure 322 from a vehicle 330. In selected embodiments, this feature can allow the portion of the defensive system 320 to be tested without firing the squib 324 and/or the countermeasure 322. In other embodiments, the squib simulator can be used to simulate selected squib, countermeasure, and/or defensive system combinations that have not been previously used (e.g., to aid in the system development/integration of various defensive systems, countermeasures, and/or squibs).

For example, in selected embodiments the countermeasure 322 and/or the squib 324 can be removed from the vehicle and replaced by the squib simulator for testing purposes (e.g., a countermeasure and/or a squib are/is not present during testing). In other embodiments the squib simulator can be coupled to the portion of the defensive system 320 without the countermeasure 322 and/or the squib 324 being removed. For example, the squib 324 can be disconnected from the portion of the defensive system 320 and the squib simulator can be coupled to the portion of the defensive system 320 to simulate the squib 324 and/or the countermeasure 322. In still other embodiments, the squib simulator can be used to simulate a squib/countermeasure that is under development and/or to test a defensive system that has never been used. Although in the illustrated embodiment the portion of the defensive system 320 is shown being carried by the vehicle 330, in other embodiments the portion of the defensive system 320 can be carried by other types of vehicles (e.g., a ground vehicle), be carried by other structures (e.g., a building), and/or be independent of a structure.

The squib simulator of one embodiment utilizes two amplifier circuits, an electronic timer, digital logic and a solid state relay that provide enhancements to facilitate the efficiency of testing these defense and/or deployment systems.

The squib simulator unit of an embodiment is built on a small, surface mount, printed circuit card. This allows the unit to be fully contained in the same cartridge housings as live countermeasures. The unit is self powered by onboard batteries. Once powered up it exhibits the same electrical characteristics as the live round. Because of this the simulators appear as live rounds to the aircraft's polling system. They exhibit the same response time in transitioning from pre fired to post fired as the live round. They also have the same post fired characteristics as the real thing.

Three individually colored LEDs are mounted at the open end of the simulator cartridge and display the status of the unit. Green indicates the unit is powered up, Red indicates the unit has been fired and is now in the post fired state. A Blue LED indicates that the unit's reset timer is running. Other colors, or lights, or indicator means can be used in alternate embodiments. The use of the LEDs (or other indicators) allows the unit to be reset from the cockpit if so desired. To utilize this function, the user sets a time range, for example, from instantaneous to ten minutes. With this feature active the unit can be reset from the cockpit by stopping the aircraft's polling system for duration longer than the reset timer is set for. Basically if the post fired unit doesn't see a polling signal within a predetermined amount of time the unit resets to the pre fired state. This function can be disabled by a DIP switch located at the open end of the cartridge. If the auto reset feature is disabled the unit will require a manual reset to return to the pre fired mode.

Principles of Operation: The aircraft sends two very different signals to each flare and chaff cartridge loaded in the aircraft's magazines. The first signal is the polling signal. It is of low amplitude so as to not initiate the unit. This signal's purpose is to detect “live” or available rounds and their location in the magazine. The second signal is of sufficient voltage and current to initiate the round. This signal is used to deploy the round. Each countermeasure is electrically connected to the aircraft by two contacts on the outside of the units casing. Both of the signals travel through these contacts. The squib simulator has to monitor and respond to each signal differently.

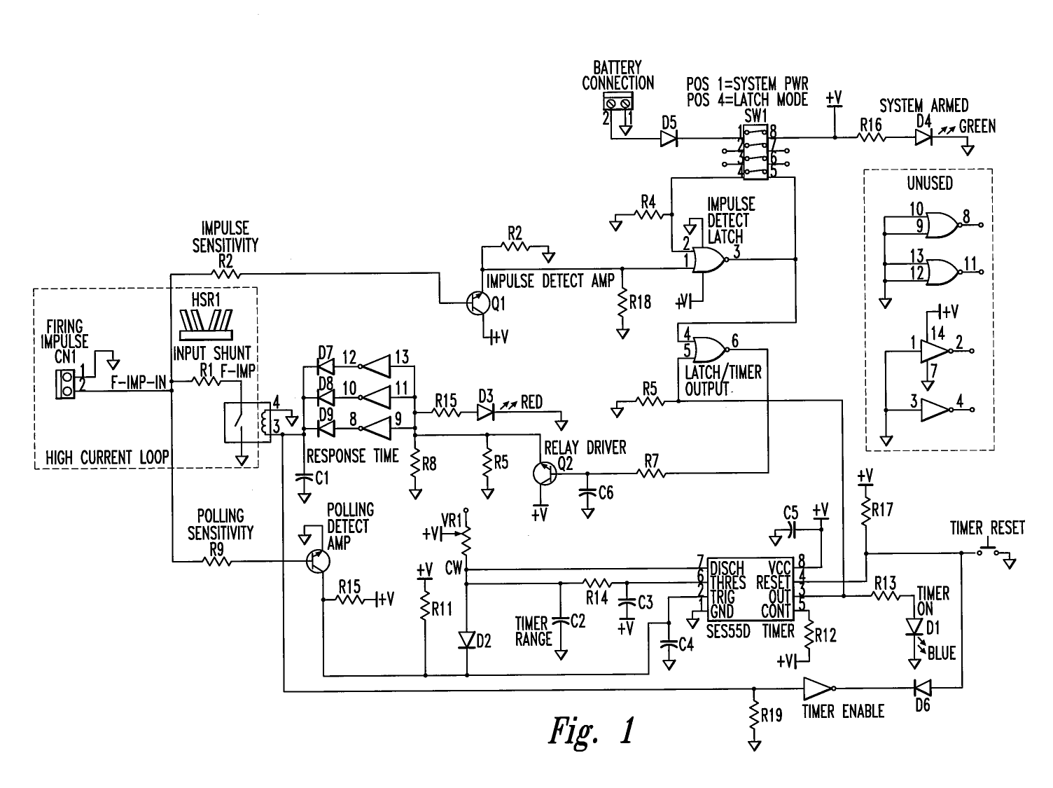

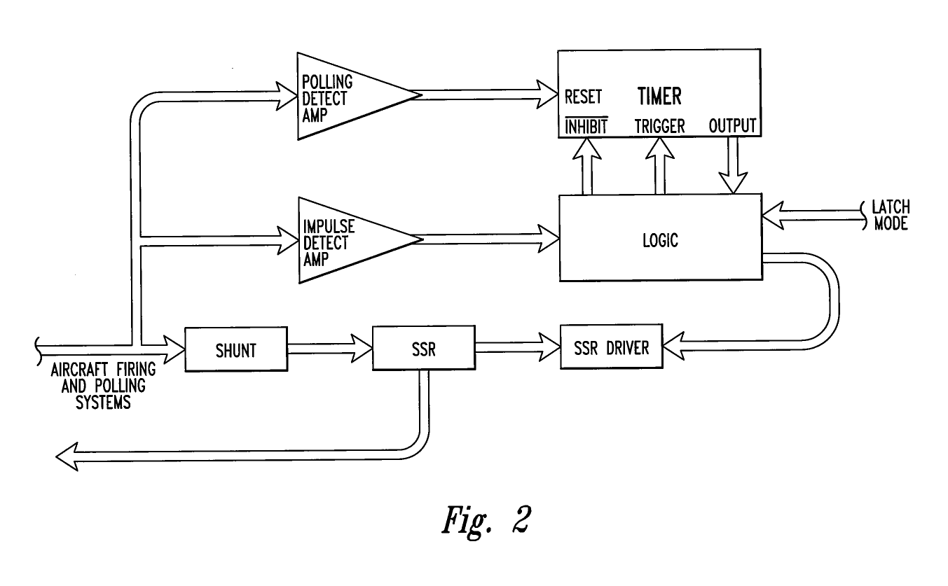

In the illustrated embodiment and with reference to FIGS. 1 and 2, the squib simulator has two amplifier circuits monitor these signals. The first amplifier is low gain and is tuned to respond to the initiate signal. When the initiate signal is detected the units transfers to the post fired state in a specific time interval. This interval is designed to mimic the response time of an actual squib (initiator). If the simulator is in “Latch” mode when it detects the initiate signal it locks itself into the post fired state via a digital latching circuit. It will remain in this state until it is manually reset, even if the batteries are fully depleted. If the unit is in the “Timer” mode when it receives the initiate signal it transfers to the post fired state and starts the timer.

The second amplifier circuit is high gain and monitors the polling signal. If the polling signal is detected before the timer reaches the preset time interval the timer is reset to zero and starts the time interval again. The simulator remains in the post fired state until the timer reaches the preset time interval setting without detecting a polling signal. This provides the capability of maintaining the post fired state after initiation for as long as desired and allowing the simulator to be reset to the pre fired state from the cockpit by simply turning off the polling signal. Because of the much higher gain or sensitivity of the second amplifier it could also detect the polling signal while the simulator is in the pre fired mode. This would start the timer which would cause the simulator to transfer to the post fired state in error. To prevent this from occurring the simulator incorporates a digital lock or inhibit on the timer. This inhibit function disables the timer until the simulator detects an initiate signal and transfers to the post fired state.

The simulator's pre fired state places a specific resistance value in series with the initiate circuit. This resistance value is designed to be equivalent to an actual live squib in circuit impedance. This satisfies the aircraft's polling system which in turn sees this as a live, pre fired countermeasure round. When the simulator transfers to the post fired state this resistance value is removed from the initiate circuit path. This in conjunction with the high input impedance of both amplifiers creates a near infinity impedance value which the aircraft's polling systems sees as a spent or fired round.

1. A printed circuit board for testing a portion of a defensive system configured to deploy a countermeasure, comprising:
an indicator circuit configured to simulate a characteristic of a countermeasure squib, the indicator circuit having at least two states including a ready state and an unavailable state;
a switching circuit operably coupled to the indicator circuit to switch the indicator circuit between the at least two states, wherein when the indicator circuit is in the ready state, the switching device is configured to switch the indicator circuit from the ready state to the unavailable state upon receipt of a fire command from a portion of a vehicle defensive system with a time delay at least approximately the same as that associated with firing the countermeasure squib; and
a timing device operably coupled to the switching circuit and configured to command the switching circuit to switch the indicator circuit from the unavailable state to the ready state if a polling signal is not received within a selected period of time while the indicator circuit is in the unavailable state.

2. A simulation device, comprising:
an indicator circuit configured to simulate a characteristic of a countermeasure initiation device, the indicator circuit being switchable between at least two states including a ready state and an unavailable state; and
a switching circuit operably coupled to the indicator circuit to switch the indicator circuit between the at least two states.

3. The device of claim 2 wherein the ready state of the indicator circuit is associated with a first resistance and the unavailable state is associated with a second resistance.

4. The device of claim 2 wherein the ready state of the indicator circuit is associated with a first impedance and the unavailable state is associated with a second impedance.

5. The device of claim 2 wherein the switching circuit is configured to cause the indicator circuit to switch to the unavailable state upon receipt of a selected voltage and a selected current.

6. The device of claim 2, further comprising indicator lights configured to annunciate the status of the simulation device.

7. The device of claim 2 wherein the switching circuit includes a DIP switch to at least one of reset the simulation device, change the state of the indicator circuit, and control the logic associated with the switching circuit.

8. The device of claim 2 wherein the indicator circuit and the switching circuit are carried on one or more printed circuit boards.

9. The device of claim 2 wherein the countermeasure initiation device includes a squib.

10. The device of claim 2, further comprising a timing device, the timing device being operably coupled to the switching circuit, the timing device and switching circuit being configured to switch the indicator circuit from the unavailable state to the ready state if a polling signal is not received within a selected period of time while the indicator circuit is in the unavailable state.

11. The device of claim 2 wherein the switching device is configured to switch the indicator circuit from the ready state to the unavailable state upon receipt of a fire command from a portion of a vehicle defensive system while the indicator circuit is in the ready state.

12. The device of claim 2 wherein when the indicator circuit is in a ready state, the switching device is configured to switch the indicator circuit from the ready state to the unavailable state upon receipt of a fire command from a portion of a vehicle defensive system with a time delay at least approximately the same as that associated with operation of the countermeasure initiation device.

13. The device of claim 2 wherein the simulation device is configured to be operably coupled to a portion of a vehicle defensive system.

14. The device of claim 2 wherein the simulation device is configured to be operably coupled to a portion of a vehicle defensive system, the vehicle defensive system being configured to deploy at least one of a flare and chaff.

15. A method of testing a portion of a vehicle defensive system, comprising:
receiving an input at a countermeasure simulation device from a portion of a vehicle defensive system; and
providing an output from the countermeasure simulation device associated with one of at least two states, the states simulating a characteristic of a selected countermeasure; the at least two states including a ready state and a unavailable state.

16. The method of claim 15, further comprising switching the countermeasure simulation device from the ready state to the unavailable state in response to an input that includes a fire command.

17. The method of claim 15, further comprising switching the countermeasure simulation device from the unavailable state to the ready state when the input includes the absence of a polling signal during a selected period of time while the countermeasure simulation device is in the unavailable state.

18. The method of claim 15, further comprising switching the countermeasure simulation device from the unavailable state to the ready state when the input includes a signal from a manually actuated switch.
